(19) United States
(12) Patent Application Publication
(10) Pub. No.: US 2008/0271802 A1
(43) Pub. Date: Nov. 6, 2008

(54) Pipe rehabilitating material and pipe rehabilitating method

(75) Inventors: Takao Kamiyama, Hiratsuka-shi (JP); Kazuki Shimizu, Hiratsuka-shi (JP); Kunio Nishimura, Kanagawa-ken (JP)

Correspondence Address: BRUCE L. ADAMS, ESQ.;ADAMS & WILKS, SUITE 1231, 17 BATTERY PLACE, New York, NY, 10004, US

(73) Assignee: SHONAN GOSEI-JUSHI SEISAKUSHO K.K.

(21) Appl. No.: 12/079,492

(22) Filed: Mar. 27, 2008

(30) Foreign Application Priority Data
Mar. 28, 2007 (JP) 2007-084011

(51) Int. Cl. F16L 55/16; F16L 11/00

(52) U.S. Cl. 138/98; 138/125

(57) ABSTRACT

A lining material composed of felt impregnated with a thermosetting resin is used to line a pipe to be rehabilitated. 0.5 to 30 wt % of a filler containing at least carbon nanotubes is added to the thermosetting resin impregnated in the felt of the lining material in order to improve the thermal conductivity of the felt. The thermal conductivity is greatly improved up to 0.3 W/m·K or greater over the conventional thermal conductivity of 0.2 W/m·K, making it possible to reduce the time needed for heating, and to heat the lining material more uniformly.

### BACKGROUND OF THE INVENTION

1. Field of the Invention

The present invention relates to a pipe rehabilitating material for rehabilitating an aged pipe, and to a pipe rehabilitating method that uses this pipe rehabilitating material to line the internal peripheral surface of a pipe to be rehabilitated.

2. Description of the Prior Art

For cases in which underground sewerage pipes or industrial pipes become aged, a pipe rehabilitating method has already been proposed and is being performed for repairing and reinforcing the aged pipes by lining their internal peripheral surfaces without digging out the pipes (for example, see Japanese Laid-open Patent Application No. 1985-242038). Specifically, this pipe rehabilitating method uses a pipe-shaped lining material in which a flexible felt whose surface is film-coated is impregnated with a thermosetting resin. This lining material is inserted into an aged pipe while being everted by fluid pressure, and is press-fitted against the internal peripheral surface of the aged pipe. From this state, hot water or steam is introduced as a heating medium to heat the interior of the pipe-shaped lining material and to cure the thermosetting resin contained therein. This allows a new rehabilitated pipe to be formed from the lining material on the internal peripheral surface of the aged pipe.

In this pipe rehabilitating method, heating is performed indirectly using hot water or steam as the medium for heating and curing the thermosetting resin impregnated in the lining material used, but hot water must be continuously circulated until the thermosetting resin is cured. Therefore, there has been a problem in that long curing times consume large amounts of energy for heating.

Pipe rehabilitating materials made of resins inherently have poor thermal conductivity, require long heating times, and suffer high heat loss. However, no methods have yet been devised for improving the thermal conductivity of rehabilitating materials in order to prevent this energy loss. There are examples of conventional methods in which a filler of an inorganic material is added in order to improve the physical properties of the pipe rehabilitating material. Aluminum hydroxide is an example of a filler added to improve physical properties, but the addition is made in order to control viscosity and to prevent unsatisfactory curing of the resin due to a quick reaction, and the thermal conductivity issue is not resolved.

In practice, the addition of aluminum hydroxide improves the thermal conductivity up to merely 0.25 W/m·K.

An object of the present invention is to resolve these problems and to provide a pipe rehabilitating material and a pipe rehabilitating method that uses this pipe rehabilitating material, wherein the thermal conductivity of the thermosetting resin impregnated in the lining material is improved, thermal energy loss is reduced, and thermal efficiency is enhanced, thereby making it possible to reduce the time required for heating.

### SUMMARY OF THE INVENTION

In the present invention, one or more carbon materials containing at least carbon nanotubes are added to a thermosetting resin impregnated into the lining material. The lining material with carbon nanotubes added is inserted while being everted by fluid pressure into an aged pipe and is pressed against the internal peripheral surface of the aged pipe. From this state, hot water or steam is introduced as a medium into the pipe-shaped lining material and is heated to cure the thermosetting resin contained therein, whereby a new rehabilitated pipe is formed from the lining material on the internal peripheral surface of the aged pipe. According to the present invention, the thermal conductivity of the thermosetting resin impregnated into the lining material is improved.

The present invention concerns a pipe rehabilitating material and a pipe rehabilitating method that uses this material, wherein the thermal conductivity of the felt impregnated with the thermosetting resin is 0.3 W/m K or greater. The thermal conductivity is greatly improved over the conventional thermal conductivity of 0.2 W/m·K, making it possible to reduce the time needed for heating, and to heat the lining material more uniformly.

In the present invention, in order to improve the thermal conductivity of the pipe rehabilitating material, the thermal conductivity of the lining material is improved by adding at least carbon nanotubes or a carbon material containing carbon nanotubes or the like as a filler to the thermosetting resin.

The carbon nanotubes used in the present invention are fibrous multilayer carbon nanotubes wherein many graphite sheets composed of carbon atoms are stacked in a rounded concentric formation in the form of a cylinder. The fiber diameter is extremely small on a scale of nanometers, while the fiber length (length in the axial direction) reaches a scale of micrometers. The aspect ratio (ratio of fiber length to fiber diameter) is therefore extremely high.

Thus, since the fiber diameter is small and the aspect ratio is high, the bulk density is high, the solid structure is easy to create, filler effects can be obtained, and high thermal conductivity can be achieved. The carbon nanotubes used herein are obtained by CVD and have variations in the diameter and length. Some nanotubes have bifurcated shapes, and carbon that is partially particulate is also contained. However, the effects of improving thermal conductivity are not compromised because the effects are exhibited in the cleaned portions. The resulting carbon nanotubes are heat-treated at a temperature of 1200° C. or greater, and are then crushed. Using as high of a heat treatment temperature as possible results in higher thermal conductivity, and the temperature is therefore preferably 2500° C. or greater, which results in significant filler effects. The added filler can also be carbon nanotubes alone, or a mixture of a plurality of fillers, including carbon nanotubes, other carbon materials, inorganic materials, metal powders, and the like.

Carbon materials that can be mixed and used include carbon nanocoils, carbon black, graphite powders, carbon fibers, and the like.

The carbon nanotubes and other carbon materials being used have high electrical and thermal conductivity and chemical resistance, and are also lightweight and easy to handle. Therefore, these materials can also be added to thermosetting resins as fillers that provide these resins with additional properties.

In the present invention, the amount of filler containing carbon nanotubes added to the thermosetting resin is 0.5 wt % or greater and 30 wt % or less. The amount of the carbon nanotubes added to improve thermal conductivity is preferably at least 0.5 wt % or greater. If the amount of filler containing carbon nanotubes added to the thermosetting resin is less than 0.5 wt %, the desired thermal conductivity cannot be obtained. If the amount added exceeds 30 wt %, an extremely high cost is incurred, fluidity is reduced, and strength is also reduced, which is not suitable for the impregnation step.

In the present invention, the aspect ratio of carbon nanotubes added to the thermosetting resin is at least 10 or greater, and is preferably 100 or greater.

In the present invention, the fiber diameter of the carbon nanotubes added to the thermosetting resin is 20 nm or greater, and is preferably 50 nm or greater. If the fiber diameter is less than 20 nm, the fiber strength is low, and the fibers become intertwined during mixing to form flocs, making it difficult to exhibit their functions. The diameter described herein has a distribution and is depicted by a mean diameter.

Furthermore, in the present invention, the fiber length of the carbon nanotubes added to the thermosetting resin is at least 200 nm or greater, and is preferably 500 nm or greater. Longer fibers in the carbon nanotubes make it possible to ensure a greater heat transfer distance.

In the present invention, adding a filler containing at least carbon nanotubes to a resin impregnated into felt makes it possible to improve the thermal conductivity of the felt, to reduce heat loss, to efficiently heat and uniformly cure the resin, and to reduce operation time, in comparison with conventional methods.

Further features of the invention, its nature and various advantages will be more apparent from the accompanying drawings and following detailed description of the invention.

### BRIEF DESCRIPTION OF THE DRAWINGS

FIG. 1 is an illustrative view showing a method of adding a filler to the thermosetting resin used in the pipe rehabilitating method according to the present invention;

FIG. 2 is an illustrative view showing the configuration of a lining material used in the pipe rehabilitating method according to the present invention;

FIG. 3 is an illustrative view showing an embodiment wherein a pipe is rehabilitated using a lining material according to the present invention;

FIG. 4 is a micrograph of the carbon nanotubes used in the pipe rehabilitating material according to the present invention;

FIG. 5 is an illustrative view showing a method of impregnating the felt with the resin in the process of creating a sample for measuring thermal conductivity in the pipe rehabilitating material according to the present invention; and

FIG. 6 is an illustrative view showing a tool used a method for curing the resin impregnated in the felt in the process of creating a sample for measuring thermal conductivity.

### DESCRIPTION OF THE PREFERRED EMBODIMENTS

Preferred embodiments of the present invention will be described with reference to the drawings. The embodiments depicted hereinafter are provided to describe the present invention and allow for various other modifications, and the scope of the present invention must not be interpreted to be limited by the embodiments hereinafter described. The shapes of elements and other features in the drawings emphasize a clearer description and must not be interpreted to be limiting of the design and dimensions of the elements in the present invention.

FIG. 1 describes a method used with the filler added to the pipe rehabilitating material according to the present invention or to the thermosetting resin used in the method. A liquid thermosetting resin 2, e.g., unsaturated polyester, a vinyl ester, an epoxy resin, or the like, is added to a container 1. A filler or another such additive is then added to the container 1. The filler contains a filling agent composed of aluminum hydroxide, silica, talc, calcium carbide, or the like; a curing agent that produces radicals when thermally decomposed; and at least carbon nanotubes. The mixture is then stirred with a propeller 3. It is not particularly relevant whether the stirring is performed in a closed system or an open system, and the shape of the propeller, the rotational speed, the sequence in which the propeller is introduced, and the stirring time differ according to the combined materials and their compositions. The optimum factors for the materials are therefore used.

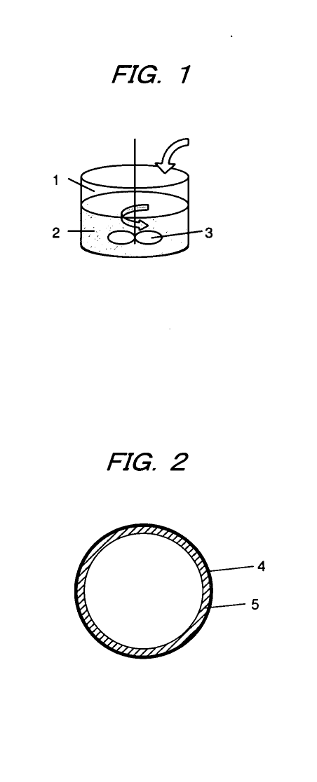

FIG. 2 shows a lining material configured by impregnating felt with the thermosetting resin. The external peripheral surface of the lining material is composed of a film 4 made of urethane, polyethylene, or another material that is airtight, watertight, and has high electrical insulation properties. The film 4 is used as a coating on a felt 5 made of polyester. The felt 5 is impregnated with the thermosetting resin.

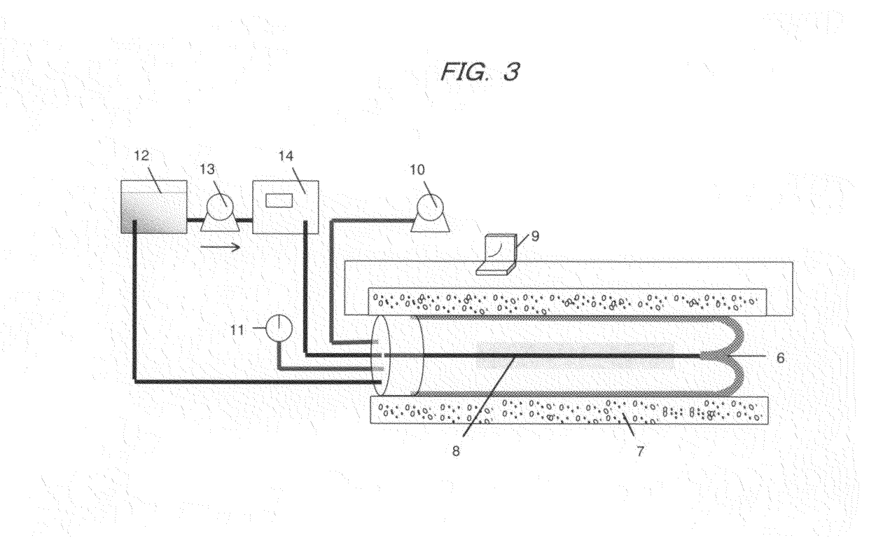

Next, in FIG. 3, the lining material 6 created through the steps shown above is inserted while being everted into an aged pipe 7 by means of fluid pressure with the use of a compressor 10 or the like, and the lining material is pressed against the internal peripheral surface of the aged pipe. Water from a tank 12 is supplied via a rotary pump 13 to a boiler 14 to produce hot water or steam, which is introduced as a heat medium into the lining material from a hose 8 to cure the thermosetting resin impregnated in the lining material 6. The use of the resin having improved thermal conductivity in these steps results in less heat loss than in cases in which a conventional resin is used, and also makes it possible to heat the resin more efficiently to facilitate curing and to reduce operation time.

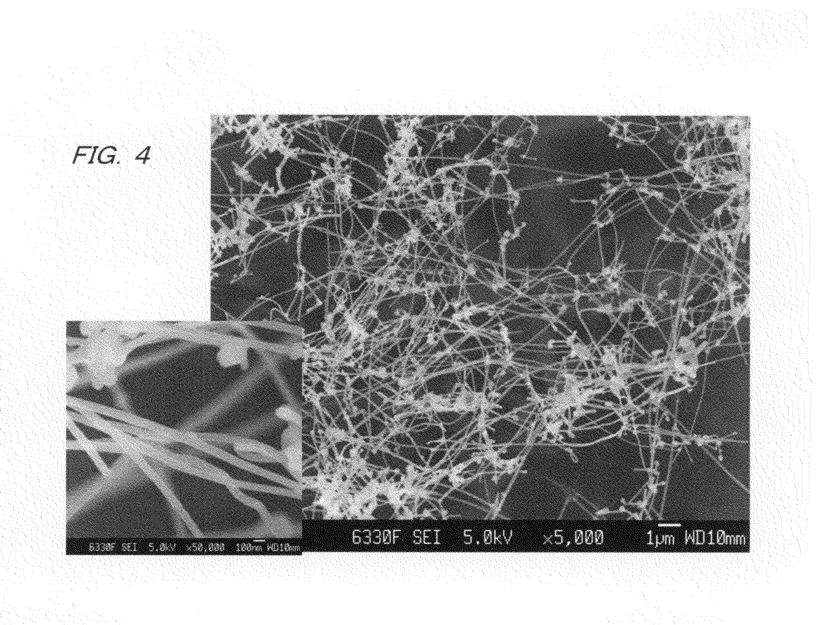

FIG. 4 shows a micrograph of the carbon nanotubes used in the present invention. The method for manufacturing the carbon nanotubes involves synthesizing the carbon nanotubes by CVD using hydrogen carbide as a starting material, wherein the fiber diameter and length can be controlled by adjusting the conditions therein. The fiber diameter, fiber length, and aspect ratio described herein show typical numerical values.

The present invention will be described in detail hereinbelow based on the embodiments.

### Embodiment 1

800 g of the unsaturated polyester resin 2 were added to the container 1 shown in FIG. 1, then 3 wt % of the carbon nanotubes in relation to the resin was added, and the propeller 3 was used to stir the mixture for 15 min at a rotational speed of 500 rpm. 8.8 g of t-butyl peroxy 2-ethylhexanoate and 4.4 g of bis(4-t-butyl cyclohexyl)peroxy dicarbonate were then added as curing agents, and the mixture was stirred for 15 min at a rotational speed of 500 rpm.

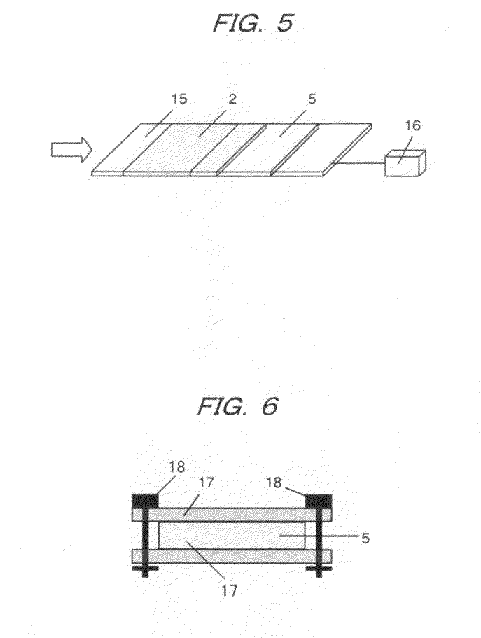

Next, the process of impregnating the felt with the created resin will be described with reference to FIG. 5. A flat piece of felt 5 made of polyester was inserted into a pipe-shaped tube 15 composed of polyethylene, the resin 2 was introduced from the direction indicated by the arrow, the tube was hermetically sealed, and a vacuum pump 16 was used to create a vacuous state to impregnate the felt 5 with the resin 2.

Next, the impregnated felt 5 was sandwiched between iron plates 17 using bolts and nuts 18 as shown in FIG. 6. The thickness of the felt 5 was set to 12 mm, and the felt 5 was immersed in a 60° C. hot water bath, where it was heated and cured for 60 to 90 min.

The cured felt was cut into squares measuring 150 mm×170 mm, and plate-shaped samples were prepared in order to measure the thermal conductivity. The measurements showed that the resulting thermal conductivity was 0.54 W/m K, as shown in the following Table.

| | | Amount added | Thermal conductivity |
|---|---|---|---|
| | Type of filler added | [wt %] | [W/m · K] |
| E1 | Carbon nanotubes | 3 | 0.5416 |
| E2 | | 5 | 0.7508 |
| C1 | None | — | 0.1982 |
| C2 | Aluminum hydroxide | 20 | 0.2538 |
| C3 | Carbon black | 10 | 0.2178 |
| C4 | Graphite | 10 | 0.2661 |

In the Table, E1 indicates the above-mentioned Embodiment 1, E2 the following Embodiment 2, and C1 through C4 comparative Examples 1 through 4. Thermal conductivity is measured by measurement device: Kemtherm QTM-D3 by Kyoto Electronics Manufacturing Co., Ltd.

### Embodiment 2

5 wt % of the carbon nanotubes was added to prepare a sample in the same manner as in Embodiment 1. Thermal conductivity measurements showed that the resulting thermal conductivity was 0.75 W/m K, as shown in the above Table.

### Embodiment 3

Similar to the previous embodiments, 5 wt % of carbon nanotubes was added to 10.5 kg of an unsaturated polyester resin and stirred, and 115.5 g of t-butyl peroxy 2-ethylhexanoate, 57.8 g of bis(4-t-butyl cyclohexyl)peroxy dicarbonate, and other such materials were then added as curing agents and stirred to create a resin.

Next, a lining material having a diameter of 250 mm and a length of 3 m was impregnated with the resin created as previously described. The lining material was formed into a pipe shape from flexible felt that was coated with a film on the surface. Curing tests were performed with the configuration shown in FIG. 3. Specifically, the lining material 6 was inserted into the aged pipe 7 while being everted at a pressure of 0.04 MPa with the use of the compressor 10, and was pressed against the internal peripheral surface of the aged pipe 7 at a pressure of 0.06 MPa. From this state, hot water was introduced as a heat medium into the lining material 6 from the hose 8 to heat and cure the resin. The curing schedule was 45 min at 60° C., and then 45 min at 85° C. As a result, it was confirmed that the curing time could be reduced in comparison with conventional practice.

### Comparative Examples

Next, as comparative examples, four types of fillers were used to measure the thermal conductivities of the respective thermosetting resins in the same steps as in the Embodiments. The thermal conductivities are shown in Table (C1, C2, C3 and C4).

According to Table, it is clear that the thermal conductivity is improved by adding carbon nanotubes, and it is possible to improve on conventional thermal conductivity by two to three times.

What is claimed is:

1. A pipe rehabilitating material that is configured to be tubular and composed of film-coated flexible felt that is impregnated with a thermosetting resin, the lining material being inserted into a pipe to be rehabilitated, and heated to cure the thermosetting resin therein in order to line the pipe, wherein the thermal conductivity of the felt impregnated with the thermosetting resin is made to be 0.3 W/m K or greater.

2. A pipe rehabilitating material according to claim 1, wherein at least carbon nanotubes or a carbon material containing carbon nanotubes is added as a filler in order to improve the thermal conductivity of the thermosetting resin impregnated into the felt.

3. A pipe rehabilitating material according to claim 2, wherein the amount of filler containing carbon nanotubes added to the thermosetting resin is 0.5 to 30 wt %.

4. A pipe rehabilitating material according to claim 2, wherein the aspect ratio of the carbon nanotubes added to the thermosetting resin is at least 10 or greater, and is preferably 100 or greater.

5. A pipe rehabilitating material according to claim 2, wherein the fiber diameter of the carbon nanotubes added to the thermosetting resin is 20 nm or greater, and is preferably 50 nm or greater.

6. A pipe rehabilitating material according to claim 2, wherein the fiber length of the carbon nanotubes added to the thermosetting resin is at least 200 nm or greater, and is preferably 500 nm or greater.

7. A method for rehabilitating a pipe comprising the steps of:
preparing a tubular lining material composed of film-coated flexible felt that is impregnated with a thermosetting resin, the thermal conductivity of the felt impregnated with the thermosetting resin being made to be 0.3 W/m K or greater,
inserting the tubular lining material into a pipe to be rehabilitated and pressed against the internal peripheral surface thereof; and
heating the lining material to cure the thermosetting resin in order to line the pipe.

8. A pipe rehabilitating method according to claim 7, wherein at least carbon nanotubes or a carbon material containing carbon nanotubes is added as a filler in order to improve the thermal conductivity of the thermosetting resin impregnated into the felt.

9. A pipe rehabilitating method according to claim 8, wherein the amount of filler containing carbon nanotubes added to the thermosetting resin is 0.5 to 30 wt %.

10. A pipe rehabilitating method according to claim 8, wherein the aspect ratio of the carbon nanotubes added to the thermosetting resin is at least 10 or greater, and is preferably 100 or greater.

11. A pipe rehabilitating method according to claim 8, wherein the fiber diameter of the carbon nanotubes added to the thermosetting resin is 20 nm or greater, and is preferably 50 nm or greater.

12. A pipe rehabilitating method according to claim 8, wherein the fiber length of the carbon nanotubes added to the thermosetting resin is at least 200 nm or greater, and is preferably 500 nm or greater.
